(19) United States
(12) Patent Application Publication
(10) Pub. No.: US 2005/0086752 A1
(43) Pub. Date: Apr. 28, 2005

(54) Rotary toothbrush

(76) Inventor: Hong Jai Lee, Glendale, CA (US)

Correspondence Address: PARK & SUTTON LLP, 3255 WILSHIRE BLVD, SUITE 1110, LOS ANGELES, CA, 90010, US

(21) Appl. No.: 10/694,228

(22) Filed: Oct. 28, 2003

(51) Int. Cl. A61C 17/26

(52) U.S. Cl. 15/23

(57) ABSTRACT

A rotary toothbrush including a housing, a brush that is rotatably attached to the housing, and a motor, which is installed inside the housing and rotates the brush, is provided. The brush includes a first end that is rotatably attached to the housing, and a second end that is opposite to the first end. The diameter of the brush increases toward the second end. The diameter of the brush linearly increases from the first end to the second end. Alternatively, the diameter of the brush exponentially increases from the first end to the second end. The brush may further comprise a portion that has a constant diameter near the second end. A shaft connects the brush and the motor. The rotational speed of the shaft is adjustable. The rotary toothbrush further includes a cover that partially covers the brush in an arc.

### BACKGROUND OF THE INVENTION

The present invention relates to a rotary toothbrush.

More particularly, this invention relates to a electrically operated rotary toothbrush with a rotating brush, the diameter of which increases toward its free end.

There are many rotary toothbrushes by prior art.

U.S. Pat. No. 3,451,086 to Burgett discloses a motor powered rotary toothbrush having a reciprocating cylindrical brush, and a brush shield.

U.S. Pat. No. 3,739,416 to Kurachi discloses a hygienically shielded rotary toothbrush having a brush shield.

U.S. Pat. No. 4,275,749 to Caroli discloses an electrically driven continuous toothbrush that has an interchangeable brush and a protective cap.

U.S. Pat. No. 4,335,480 to Liu discloses an electric rotary toothbrush having an integral stem and brush guard housing, and a removable brush.

U.S. Pat. No. 4,882,801 to Benz discloses an electric toothbrush having a gravity-induced movement responsive switch that automatically reverses the direction of rotation.

U.S. Pat. No. 5,044,035 to Barradas discloses a dental cleaning device having helical brush tufts and a partial shield for collecting particles.

U.S. Pat. No. 5,428,855 to Li discloses a rotatable toothbrush having two brushes rotating in opposite directions with each other.

U.S. Pat. No. 5,794,296 to Wong discloses an electric toothbrush having a direction controller that controls the direction of brush rotation and stabilizes the toothbrush during brushing operation.

U.S. Pat. No. 5,864,911 to Arnoux et al. discloses a toothbrush with a dual rotary brushing system that has two adjacent contra-rotating brushes, and flexible shafts driving the brushes.

While rotary toothbrushes by prior art provides various functionalities regarding rotation of the brushes and covering the brushes, all of them use cylindrical brushes for teeth brushing operations. None of them provides brushes that have a shape adapted specifically to the shape of the teeth and thus optimized to the tooth-brushing operation.

### SUMMARY OF THE INVENTION

The present invention contrives to solve the disadvantages of the prior art.

An objective of the invention is to provide a rotary toothbrush having a brush that has a shape adapted to the shape and arrangement of the teeth.

Another objective of the invention is to provide a rotary toothbrush having a brush that is optimized to tooth-brushing operation.

Still another objective of the invention is to provide a rotary toothbrush that provides control of brush and protection of soft tissues of the oral cavity from the rotating brush.

To achieve the above objectives, a rotary toothbrush including a housing, a brush that is rotatably attached to the housing, and a motor, which is installed inside the housing and rotates the brush, is provided. The brush includes a first end that is rotatably attached to the housing, and a second end that is opposite to the first end. The diameter of the brush increases toward the second end.

The diameter of the brush linearly increases from the first end to the second end. Alternatively, the diameter of the brush exponentially increases from the first end to the second end. The brush may further comprise a portion that has a constant diameter near the second end.

A shaft connects the brush and the motor. The rotational speed of the shaft is adjustable.

The rotary toothbrush further includes a cover that partially covers the brush in an arc when it is viewed in a plane perpendicular to the shaft. The size of the arc is in a range from about 45° to about 180°.

The motor selectively rotates the brush either clockwise or counterclockwise. The motor is powered by an electric battery. Alternatively, the motor is powered by household alternating current.

The advantages of the present invention are: (1) the brush is effective in cleaning between teeth; (2) the brush is advantageous in reaching deeply into the oral cavity.

Although the present invention is briefly summarized, the fuller understanding of the invention can be obtained by the following drawings, detailed description and appended claims.

### DESCRIPTION OF THE FIGURES

These and other features, aspects and advantages of the present invention will become better understood with reference to the accompanying drawings, wherein:

FIG. 1 is an elevation view of a rotary toothbrush according to the present invention;

FIG. 2 is a side elevation view of the toothbrush showing a cover that partially covers a rotating brush;

FIG. 3 is a view similar to FIG. 2 and shows a different size of the cover;

FIG. 4 is a schematic view showing the operation of the toothbrush;

FIG. 5 is a partial elevation view showing a first embodiment of the rotating brush;

FIG. 6 is a partial elevation view showing a second embodiment of the rotating brush;

FIG. 7 is a partial elevation view showing a third embodiment of the rotating brush; and

FIG. 8 is a schematic cross-sectional view of the rotary toothbrush.

### DETAILED DESCRIPTION OF THE INVENTION

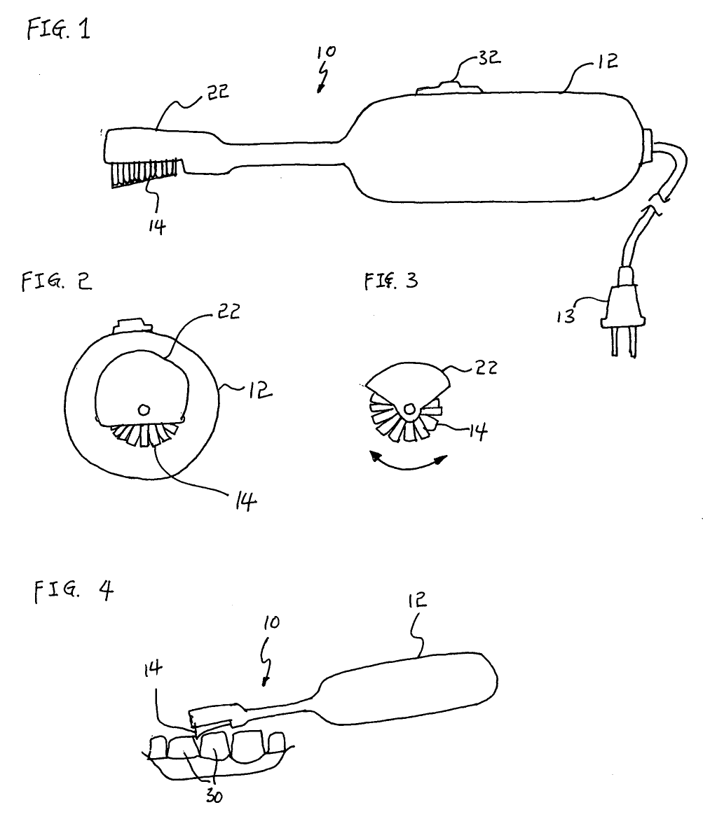

FIG. 1 shows a rotary toothbrush 10 according to the present invention. The rotary toothbrush 10 includes a housing 12, a brush 14 that is rotatably attached to the housing 12 and a motor 16 (refer to FIG. 8) that is installed inside the housing 12 and rotates the brush 14. The motor 16 rotates the brush 14 via a gear train 18 that reduces the rotational speed, and a shaft 20 that connects between the gear train 18 and the brush 14. The motor 16 may be powered by household alternating current as in FIG. 1, which shows an electric plug 13 that is adapted to an electric outlet in a house. Alternately, the motor 16 may be powered by one or more electric batteries 15 as shown in FIG. 8.

FIGS. 1-3 show that the rotary toothbrush 10 further includes a cover 22 that partially covers the brush 14 in an arc when it is viewed in a plane perpendicular to the shaft. The size of the arc is in a range from about 45° to about 180°. The cover protects soft tissues other than the teeth and gums in the oral cavity when the toothbrush 10 is operating. The size of the cover may be chosen depending on user's preference or skill to use the toothbrush 10.

FIG. 5 shows that the brush 14 includes a first end 24 that is rotatably attached to the housing 12 via the shaft 20, and a second end 26 that is opposite to the first end 24. The diameter of the brush 14 increases toward the second end 26. Specifically, FIG. 5 shows a first embodiment of the brush 12, in which the diameter of the brush 14 linearly increases from the first end 24 to the second end 26.

FIG. 6 shows a second embodiment of the brush 14, in which the diameter of the brush exponentially increases from the first end 24 to the second end 26.

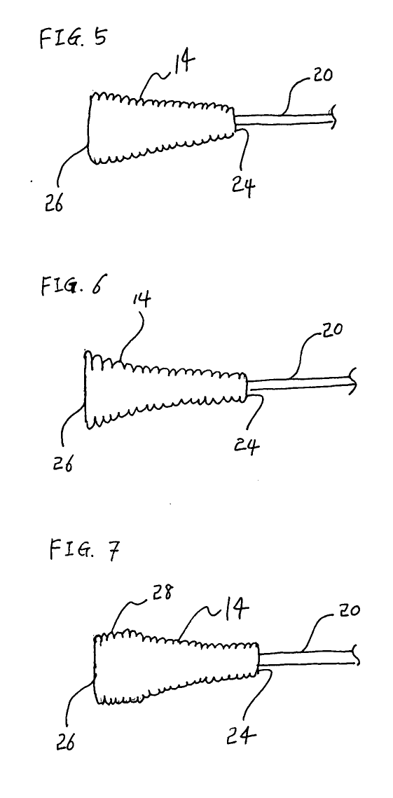

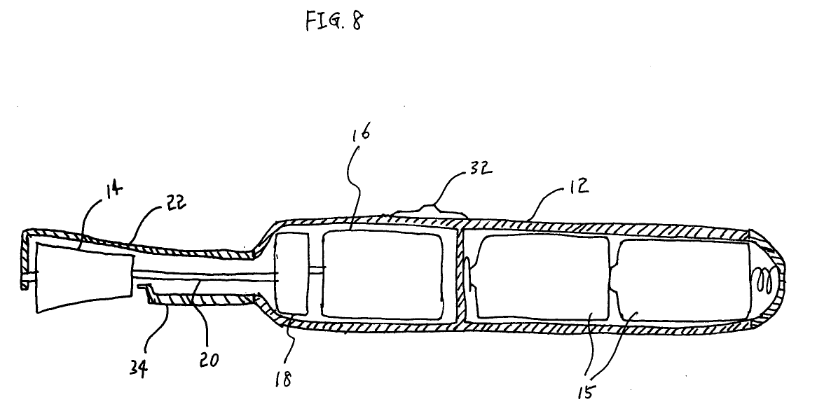

FIG. 7 shows a third embodiment the brush 14, in which the brush 14 further includes a portion 28 that has a constant diameter near the second end 26.

The various shapes enable the brush 14 to reach into further or deeper to and between the teeth, and to provide more brushing operation to bigger teeth.

In addition to the shapes shown in FIGS. 5-7, the brush 14 may have any additional portion such as a short-tapered portion at the second end 26, as far as the diameter increases gradually from the first end 24 to the second end 26 in the overall shape of the brush 14.

FIG. 4 shows the operation of brush 14 when the toothbrush 10 is used clean teeth 30. How the larger end diameter of the brush 14 facilitates cleaning between the teeth 30 is clearly understood from the illustration.

FIG. 8 shows that a control switch 32 is provided on the side of the housing 12. A user can control the motor 16 so that the motor 16 selectively rotates the brush 14 either clockwise or counterclockwise as shown in FIG. 3, or to adjust the rotational speed of the shaft 20, and thus the brush 14. The cover 22 has a neck 34 extending therefrom. The neck 34 is detachably attached to the housing 12 so that cleaning the brush 14 and the cover 22, and replacing the brush 14 are facilitated.

While the invention has been shown and described with reference to different embodiments thereof, it will be appreciated by those skilled in the art that variations in form, detail, compositions and operation may be made without departing from the spirit and scope of the invention as defined by the accompanying claims.

1. A rotary toothbrush comprising:
a) a housing;
b) a brush that is rotatably attached to the housing; and
c) a motor that is installed inside the housing and rotates the brush;
wherein the brush comprises a first end that is rotatably attached to the housing, and a second end that is opposite to the first end, wherein the diameter of the brush increases toward the second end.

2. The rotary toothbrush of claim 1, wherein the motor selectively rotates the brush either clockwise or counterclockwise.

3. The rotary toothbrush of claim 2, wherein the motor is powered by an electric battery.

4. The rotary toothbrush of claim 2, wherein the motor is powered by household alternating current.

5. The rotary toothbrush of claim 1, wherein the diameter of the brush linearly increases from the first end to the second end.

6. The rotary toothbrush of claim 5, further comprising a shaft that connects the brush and the motor.

7. The rotary toothbrush of claim 6, wherein rotational speed of the shaft is adjustable.

8. The rotary toothbrush of claim 6, further comprising a cover that partially covers the brush in an arc when it is viewed in a plane perpendicular to the shaft.

9. The rotary toothbrush of claim 8, wherein the size of the arc is in a range from about 45° to about 180°.

10. The rotary toothbrush of claim 1, wherein the diameter of the brush exponentially increases from the first end to the second end.

11. The rotary toothbrush of claim 10, further comprising a shaft that connects the brush and the motor.

12. The rotary toothbrush of claim 11, wherein rotational speed of the shaft is adjustable.

13. The rotary toothbrush of claim 11, further comprising a cover that partially covers the brush in an arc when it is viewed in a plane perpendicular to the shaft.

14. The rotary toothbrush of claim 13, wherein the size of the arc is in a range from about 45° to about 180°.

15. The rotary toothbrush of claim 1, wherein the brush further comprises a portion that has a constant diameter near the second end.

16. The rotary toothbrush of claim 15, further comprising a shaft that connects the brush and the motor.

17. The rotary toothbrush of claim 16, wherein rotational speed of the shaft is adjustable.

18. The rotary toothbrush of claim 16, further comprising a cover that partially covers the brush in an arc when it is viewed in a plane perpendicular to the shaft.

19. The rotary toothbrush of claim 18, wherein the size of the arc is in a range from about 45° to about 180°.
